(19) United States
(12) Patent Application Publication
(10) Pub. No.: US 2014/0232746 A1
(43) Pub. Date: Aug. 21, 2014

(54) THREE DIMENSIONAL AUGMENTED REALITY DISPLAY APPARATUS AND METHOD USING EYE TRACKING

(71) Applicant: Hyundai Motor Company, Seoul (KR)

(72) Inventors: Hee Jin RO, Seoul (KR); Seok Beom LEE, Seoul (KR); Dong Hee SEOK, Seoul (KR); Sung Min PARK, Seoul (KR)

(73) Assignee: HYUNDAI MOTOR COMPANY

(21) Appl. No.: 13/935,426

(22) Filed: Jul. 3, 2013

(30) Foreign Application Priority Data
Feb. 21, 2013 (KR) 10-2013-0018729

(51) Int. Cl. G06T 19/00

(52) U.S. Cl. CPC G06T 19/006
USPC 345/633

(57) ABSTRACT

A three-dimensional augmented reality display apparatus and method using eye tracking adjust a depth of an image without an increase in volume and are easily applied to an augmented reality head up display (HUD), by adjusting an angle of a total reflection prism based on positions of both eyes of a driver detected in real time using eye tracking to allow a right eye image to be formed in a driver's right eye and allow a left eye image to be formed in a driver's left eye.

### CROSS-REFERENCE TO RELATED APPLICATION

This application is based on and claims benefit of priority to Korean Patent Application No. 10-2013-0018729, filed on Feb. 21, 2013 in the Korean Intellectual Property Office, the disclosure of which is incorporated herein in its entirety by reference.

### TECHNICAL FIELD

The present disclosure relates to a three-dimensional augmented reality display apparatus and a method using eye tracking, and more particularly, to a technology capable of implementing three-dimensional augmented reality by adjusting an angle of a total reflection prism based on positions of both eyes of a driver detected in real time using eye tracking to allow a right eye image to be formed in a driver's right eye and allow a left eye image to be formed in a driver's left eye.

### BACKGROUND

A head up display (HUD), which is a front display apparatus to display driving information on a front window of a vehicle while driving, has been initially introduced in order to secure a pilot's visual field in an airplane. However, recently, the HUD has been applied to a motor vehicle as information to be delivered to a driver while driving has been increased in accordance with the development of future vehicles.

This HUD overlaps information, which is required for driving the vehicle, on a front view of a driver's visual field being displayed three-dimensionally, and the driver of the vehicle with the HUD needs not to move eyesight while driving in order to check a speed or any signal light displayed on an instrument cluster.

The HUD according to the prior art creates a virtual image at a position of 2 to 5 m from a driver's front visual field to display driving information. In this case, distance adjustment of a point at which the driving information is being displayed (depth adjustment of an image), is impossible or limited, such that the driver may sense the depth.

According to the prior art, three-dimensional display of the HUB matching with actual sight is difficult, such that there is a limitation to implement an augmented reality wind shield.

### SUMMARY

Accordingly, the present disclosure has been made to solve the above-mentioned problems occurring in the prior art while advantages achieved by the prior art are maintained intact.

An aspect of the present disclosure relates to a three-dimensional augmented reality display apparatus and method using eye tracking that are capable of adjusting a depth of an image without an increase in volume and being easily applied to an augmented reality head up display (HUD), by adjusting an angle of a total reflection prism based on positions of both eyes of a driver detected in real time using the eye tracking to allow a right eye image to be formed in a driver's right eye and allow a left eye image to be formed in a driver's left eye.

An aspect of the present disclosure describes a three-dimensional augmented reality display apparatus using eye tracking, including: an eye tracking unit for detecting three-dimensional positions of both eyes of a driver; a controlling unit for controlling a rotation angle adjusting unit to allow a left eye image to penetrate into a driver's left eye and allow a right eye image to be totally reflected on a driver's right eye, based on the positions of both eyes of the driver detected by the eye tracking unit; the rotating angle adjusting unit for adjusting a rotation angle of an image separating unit; an image outputting unit for outputting each of the left eye image and the right eye image under control of the controlling unit; and the image separating unit for penetrating the left eye image produced from the image outputting unit into the driver's left eye and totally reflecting the right eye image produced from the image outputting unit on the driver's right eye.

Another aspect of the present invention describes a three-dimensional augmented reality display method using eye tracking, including: detecting three-dimensional positions of both eyes of a driver by an eye tracking unit; calculating an angle of an image separating unit based on the detected positions of both eyes of the driver by a controlling unit; adjusting a rotation angle of the image separating unit according to the calculated angle by a rotation angle adjusting unit; outputting a left eye image and a right eye image by an image outputting unit; and penetrating the left eye image into a driver's left eye and totally reflecting by the image separating unit and the right eye image on a driver's right eye by the image separating unit.

### BRIEF DESCRIPTION OF THE DRAWINGS

The above and other objects, features and advantages of the present disclosure will be more apparent from the following detailed description taken in conjunction with the accompanying drawings, in which:

FIG. 1 is a configuration diagram of a three-dimensional augmented reality display apparatus using eye tracking according to an embodiment of the present invention;

FIG. 2 is an illustrative diagram of a three-dimensional augmented reality display process using eye tracking according to an embodiment of the present invention; and

FIG. 3 is a flow chart of a three-dimensional augmented reality display method using eye tracking according to an embodiment of the present invention.

### DETAILED DESCRIPTION OF THE PREFERRED EMBODIMENTS

Hereinafter, embodiments of the present invention will be described in detail with reference to the accompanying drawings. The examples of the present disclosure may, however, be embodied in different forms and should not be construed as limited to the examples set forth herein. Like reference numerals may refer to like elements throughout the specification.

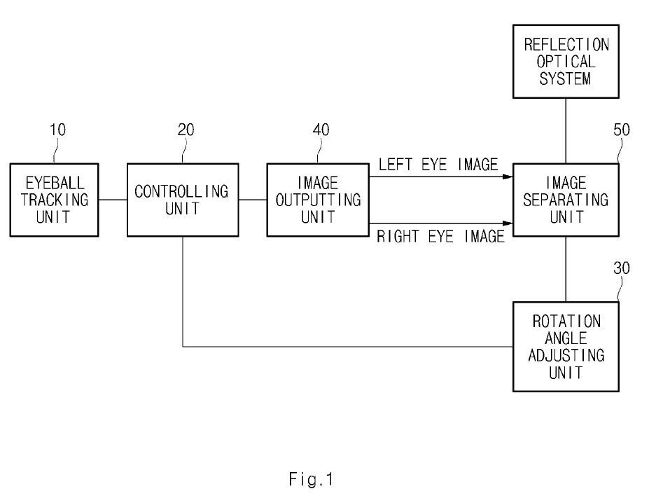

FIG. 1 is a configuration diagram of a three-dimensional augmented reality display apparatus using eye tracking according to an embodiment of the present invention.

As shown in FIG. 1, the three-dimensional augmented reality display apparatus using eye tracking according to the embodiment of the present invention is configured to include an eye tracking unit 10, a controlling unit 20, a rotation angle adjusting unit 30, an image outputting unit 40, and an image separating unit 50.

The above-mentioned respective components will be described more in detail. First, the eyeball tracking unit 10 detects a three-dimensional position (coordinate) of a driver's left eye (left eyeball) and a three-dimensional position (coordinate) of a driver's right eye (right eyeball) in real time. Since this well-known eye tracking technology may obscure the gist of the present inventive concept, a detailed description thereof will be omitted.

Next, the controlling unit 20 controls the rotation angle adjusting unit 30 to allow a left eye image to penetrate into the driver's left eye and allow a right eye image to be totally reflected on the driver's right eye based on positions of both eyes of a driver detected by the eye tracking unit 10.

Here, the controlling unit 20 creates a line of sight from the positions of both eyes of the driver detected by the eye tracking unit 10 to a position of a virtual image formed by an angle of the image separating unit 50 and calculates the angle of the image separating unit 50 to penetrate the left eye image into the driver's left eye and the right eye image to be totally reflected on the driver's right eye.

In addition, the controlling unit 20 controls the rotation angle adjusting unit 30 so that the image separating unit 50 have the calculated angle. The rotating angle adjusting unit 30 rotates the image separating unit 50 to have the calculated angle, and to transfer the left eye image from the image outputting unit 40 to the driver's left eye and the right eye image from the image outputting unit 40 to the driver's right eye.

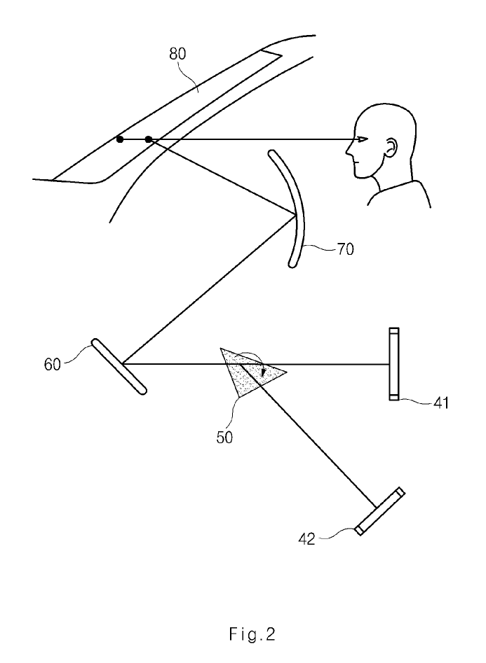

Further, the controlling unit 20 controls the image outputting unit 40 to output the left eye image and the right eye image for driving information to the image separating unit 50. Here, it is preferable to have the image outputting unit 40 includes each of a left eye image outputter 41 (See FIG. 2) and a right eye image outputter 42 (See FIG. 2) in view of implementation easiness.

Next, the rotation angle adjusting unit 30 is implemented by a step motor to adjust a rotation angle of the image separating unit 50 under a control of the controlling unit 20.

Next, the image outputting unit 40 outputs each of the left eye image and the right eye image under control of the controlling unit 20. Here, the left eye image and the right eye image are images capable of providing augmented reality to the driver.

Next, the image separating unit 50, which is a total reflection prism, penetrates the left eye image from the image outputting unit 40 into the driver's left eye and totally reflects the right eye image from the image outputting unit 40 on the driver's right eye, by angle adjustment of the rotation angle adjusting unit 30 according to the control of the controlling unit 20.

The left eye image penetrating the prism as described above is transferred to the driver's left eye through a reflecting optical system, and the right eye image totally reflected by the prism is transferred to the driver's right eye by the reflecting optical system.

Therefore, the driver may feel a three-dimensional effect through a binocular disparity image and receive driving information completely matched with a real image through the binocular disparity image. That is, the driver may receive the driving information completely matched with a real image of the front of the vehicle viewed through a windshield.

FIG. 2 is an illustrative diagram of a three-dimensional augmented reality display process using eye tracking according to an embodiment of the present invention.

As shown in FIG. 2, the left eye image from the left eye image outputter 41 penetrates the total reflection prism 50 and is then displayed on a windshield 80 of the vehicle through a reflection mirror 60 and a projection mirror 70.

At the same time, the right eye image from the right eye image outputter 42 is totally reflected on the total reflection prism 50 and is then displayed on a windshield 80 of the vehicle through the reflection mirror 60 and the projection mirror 70.

Therefore, the left eye image and the right eye image are displayed in a state in which they are overlapped with each other. In addition, since the overlapped image is completely matched with the real image of the front of the vehicle, the driver may view a three-dimensional driving information image to be overlapped with the real image of the front of the vehicle (three-dimensional augmented reality).

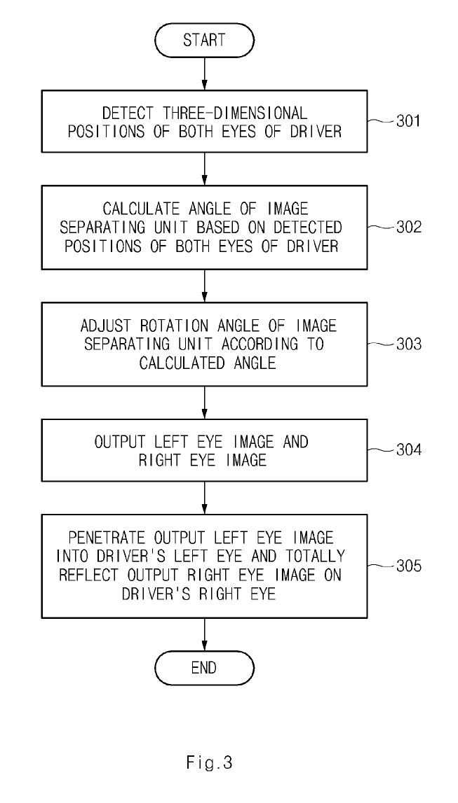

FIG. 3 is a flow chart of a three-dimensional augmented reality display method using eye tracking according to an embodiment of the present invention.

First, the eye tracking unit 10 detects the three-dimensional positions of both eyes of the driver (301).

Then, the controlling unit 20 calculates the angle of the image separating unit 50 based on the positions of both eyes of the driver detected by the eye tracking unit 10 (302).

Next, the rotation angle adjusting unit 30 adjusts the rotation angle of the image separating unit 50 according to the angle calculated by the controlling unit 20.

Next, the image outputting unit 40 outputs each of the left eye image and the right eye image under a control of the controlling unit 20 (304).

The image separating unit 50 then penetrates the left eye image from the image outputting unit 40 into the driver's left eye and totally reflects the right eye image from the image outputting unit 40 on the driver's right eye (305).

Through the above-mentioned process, a depth of the image may be adjusted without an increase in volume, and application to an augmented reality head up display (HUD) may be easy.

As set forth above, according to the embodiment of the present invention, the angle of the total reflection prism is adjusted based on the positions of both eyes of the driver detected in real time using eye tracking to allow the right eye image to be formed in the driver's right eye and allow the left eye image to be formed in the driver's left eye, such that the depth of the image may be adjusted and the application to the augmented reality head up display (HUD) may be easy.

In addition, according to the embodiment of the present invention, the binocular disparity is used, thereby making it possible to implement the three-dimensional augmented reality without an increase in volume of the HUD.

What is claimed is:

1. A three-dimensional augmented reality display apparatus using eye tracking, comprising:
an eye tracking unit detecting three-dimensional positions of both eyes of a driver;
a controlling unit controlling a rotation angle adjusting unit to allow a left eye image to penetrate into a driver's left eye and a right eye image to be totally reflected on a driver's right eye, based on the positions of both eyes of the driver detected by the eye tracking unit, wherein
the rotation angle adjusting unit adjusts a rotation angle of an image separating unit, and
an image outputting unit outputting each of the left eye image and the right eye image under control of the controlling unit, wherein
the image separating unit penetrates the left eye image from the image outputting unit into the driver's left eye and totally reflects the right eye image from the image outputting unit on the driver's right eye.

2. The three-dimensional augmented reality display apparatus according to claim 1, wherein the controlling unit creates a line of sight from the positions of both eyes of the driver detected by the eye tracking unit to a position of a virtual image formed by an angle of the image separating unit and then calculates the angle of the image to allow the left eye image to penetrate into the driver's left eye and the right eye image to be totally reflected on the driver's right eye.

3. The three-dimensional augmented reality display apparatus according to claim 2, wherein the controlling unit controls the rotation angle adjusting unit such that the image separating unit has the calculated angle.

4. The three-dimensional augmented reality display apparatus according to claim 1, wherein the controlling unit controls the rotation angle adjusting unit and controls the image outputting unit to output the left eye image and the right eye image for driving information of a vehicle.

5. The three-dimensional augmented reality display apparatus according to claim 1, wherein the image outputting unit outputs the left eye image and the right eye image matched with a real image of the front of a vehicle.

6. A three-dimensional augmented reality display method using eye tracking, comprising:
detecting, by an eyeball tracking unit, three-dimensional positions of both eyes of a driver;
calculating, by a controlling unit, an angle of an image separating unit based on the detected positions of both eyes of the driver;
adjusting, by a rotation angle adjusting unit, a rotation angle of the image separating unit according to the calculated angle;
outputting, by an image outputting unit, a left eye image and a right eye image; and
penetrating, by the image separating unit, the left eye image into a driver's left eye and totally reflecting, by the image separating unit, the right eye image on a driver's right eye.

7. The three-dimensional augmented reality display method according to claim 6, wherein in the step of calculating of the angle, a line of sight from the positions of both eyes of the driver detected by the eye tracking unit to a position of a virtual image formed by the angle of the image separating unit is created and the angle of the image separating unit allowing the left eye image to penetrate into the driver's left eye and allowing the right eye image to be totally reflected on the driver's right eye is calculated.

8. The three-dimensional augmented reality display method according to claim 6, wherein in the step of outputting of the left eye image and the right eye image, the left eye image and the right eye image for driving information of a vehicle are produced.

9. The three-dimensional augmented reality display method according to claim 6, wherein in the step of outputting of the left eye image and the right eye image, the left eye image and the right eye image matched with a real image of the front of a vehicle are produced.
